(19) United States
(12) Patent Application Publication
(10) Pub. No.: US 2002/0140313 A1
(43) Pub. Date: Oct. 3, 2002

(54) Motorized fuel pump for a vehicle

(75) Inventors: Tamotsu Noya, Sashima-gun (JP); Hiroaki Kawasaki, Sashima-gun (JP)

Correspondence Address: OLIFF & BERRIDGE, PLC, P.O. BOX 19928, ALEXANDRIA, VA, 22320, US

(73) Assignee: KYOSAN DENKI CO., LTD., Sashima-gun (JP)

(21) Appl. No.: 10/102,891

(22) Filed: Mar. 22, 2002

(30) Foreign Application Priority Data
Mar. 30, 2001 (JP) 2001-100937

(51) Int. Cl. H02K 13/00; H02K 1/00

(52) U.S. Cl. 310/233; 310/248

(57) ABSTRACT

A commutator portion or a brush of a motor is formed of electrically conductive resin. When making the commutator portion with electrically conductive resin, a commutator member is molded of non-electrically conductive resin and the commutator members are all integrally formed with the commutator support member. At this time, at least a portion of the outer periphery of the axle is formed simultaneously with an electrically conductive resin layer.

### INCORPORATION BY REFERENCE

The disclosure of Japanese Patent Application No. 2001-100937 filed on Mar. 30, 2001 including the specification, drawings and abstract is incorporated herein by reference in its entirety.

### BACKGROUND OF THE INVENTION

1. Field of the Invention

The invention relates generally to a motorized fuel pump for a vehicle for supplying fuel to a vehicle engine by means of a pump driven by a motor. More particularly, the invention relates to a motorized pump for a vehicle, which is constructed such that electrical conduction does not deteriorate in a motor in which fuel flows through the inside.

2. Description of the Related Art

Various types of motorized fuel pumps for vehicles which supply fuel by using a pump driven by a motor in a vehicle engine have been known. Of these, motorized pumps in which the pump portion is integrated with the motor portion are the most generally used, and the pump that is typically employed for the pump portion is a roller vane type, a Wesco type, an inner gear type or the like. Moreover, many motorized fuel pumps for vehicles in recent years are now being mounted inside the fuel tank. Many are also made so as to discharge the fuel after it flows from the pump through the space within the motor that drives the pump, thereby cooling the inside of the motor. One specific example of such a motorized fuel pump for a vehicle is shown in FIG. 3, for example. The related art shown in this figure is a motorized fuel pump 30 for a vehicle, in which a top cover 32 and a bottom cover 35 are crimped together by a cylindrical casing 31 so as to form a single integrated unit. Inside this casing 31 are housed a D/C motor portion 40 and a pump portion 50. Inside the top cover 32 is formed a fuel discharge port 34 having a check valve 33, and a connector portion 36 for supplying electrical current to the D/C motor portion 40. Also, inside the bottom cover 35 is formed a fuel intake port 37. The fuel is drawn in by this intake port 37, passes through the inside of the D/C motor portion 40, and is then discharged through the discharge port 34, i.e., the fuel flows inside the motorized fuel pump in the direction of the arrows shown in FIG. 3.

The D/C motor portion 40 includes a pair of magnets 38 and 39 fixed to the inner peripheral surface of the casing 31 via a motor housing 42 and the like, and an armature 44 at a predetermined space from these magnets 38 and 39, which has an axle 43 extending in the lengthwise direction of the casing 31. The armature 44, which is centered around the axle 43, includes a coil portion 45 in which coil wires are wound around laminated thin iron core sheets 49, and a vertical plate-shaped commutator 46 on the axle 43 to which each of the coil wire ends of the coil portion 45 are connected. A pair of brushes 47, which are guided in the motor housing 42 and urged by springs 48, and which are wired to the connector portion 36, make sliding contact with the commutator 46.

When selecting the material for the commutator and brushes, various materials are selected for their capability to conduct electricity, wear resistance, machinability and the like, but a copper alloy such as Cu—Cr (0.8%) is often used for the commutator and copper or carbon sintered material is often used for the brushes.

As shown in FIG. 3, the pump portion 50 includes a turbine vane 53 that has a vane portion 54 on the outer periphery. This vane portion 54 is arranged within the casing 31 between the bottom cover 35 and the pump cover 51 which is crimped to both the bottom cover 35 and the casing 31 so as to form a single integrated unit. The turbine vane 53 is retained in the rotational direction at an extending end of the axle 43 of the armature 44 of the D/C motor portion 40, and is fitted so as to be able to slide in the axial direction.

Also, the portion of the axle 43 on the left side in the figure is supported by a bearing 55 that is fixed to the pump cover 51 between the armature 44 and the turbine vane 53. Furthermore, the end of that portion of the axle 43 is received by a thrust bearing 56. Moreover, an axle support portion 57 of the portion of the axle 43 on the right side in the figure which protrudes from the sliding end face of the commutator 46 is supported by a bearing 58 that is fixed to the top cover 32. The thin iron core sheets 49 are fixed to this axle 43 by means such as press-fitting.

FIG. 4A is a front view of the commutator 46 and FIG. 4B is a side view of the commutator portion. Each of the plates of the copper alloy commutator member 58 are arranged together with slits 60 in the peripheral direction of the axle of the armature 44. The commutator member 58 is made of an electrically conductive metal and includes a first winding fixing member 63 for fixing a winding 61 to the outer periphery of the commutator member 58, and a second winding fixing member 62 for positioning that winding 61. The first winding fixing member 63 and the second winding fixing member 62 are each integrally formed. The set of the commutator member 58 and the second winding fixing member 62 is supported by a non-electrically conductive commutator support member 64 which is fixed to the periphery of the axle 43. A partition portion 65 extending in the radial direction from the commutator support member 64 extends between adjacent first winding fixing members 63. The commutator members 58 (six in this embodiment) that are integrated as described above and the first winding fixing members 63 are then all connected.

According to the fuel pump described above, because fuel flows through the inside of the motor, during the process of using the motor, when using the vehicle in a region where the fuel contains sulfur and the like, such as Southeast Asia, for example, if the fuel remains in the motor for a long period of time, an insulative coating may form on the surface of the sliding portion of the commutator, which serves as the electrically conductive portion, thus leading to a deterioration of electrical conductivity between the commutator and the brushes. This can in turn lead to poor engine starting, and, even if the engine does start, it may cause poor actuation and the like during driving. The components of the sulfur (S) in the fuel form a copper sulfide film on the surface of the commutator, which directly causes a deterioration of electrical conductivity. Not only sulfur, but various other elements and compounds produced by the fuel hose and the seal member, for example, may also produce similar films.

To solve this problem, it has been proposed to apply a Cu—Ni alloy to the surface portion of the commutator so that an insulative coating would not form, as disclosed in Patent Application Laid-Open Publication No. 2-65640, for example. It has also been proposed to provide a separate Ag—Ni alloy conductive member on the end face of the commutator and run an electric current through this member only during the start of rotation of the motor to start the pump, as disclosed in Japanese Utility Model Publication SHO 63-119887.

However, the art in which a Cu—Ni alloy is applied to the surface portion of the commutator requires surface treatment with a specific composition, which would make it expensive. Further, with the art in which a separate member is provided on the commutator, the number of parts is increased, which both increases the cost of the product as well as increases man-hours in production which would also ultimately increase the cost.

### SUMMARY OF THE INVENTION

Therefore in view of the foregoing problems, it is the object of this invention to provide a motorized fuel pump for a vehicle, which operates stably over a long period of time.

The motorized fuel pump for a vehicle according to a first aspect of the invention includes a commutator member made of an electrically conductive resin, and a brush of electrically conductive resin which makes slidable contact with the commutator member.

The first aspect of the invention enables stable operation over a long period of time without the need for a special surface treatment with a specific metal, without using special parts, and without an insulative coating forming on the commutator even if the fuel properties are poor or the fuel remains in the motor for a long period of time.

A motorized fuel pump for a vehicle according to a second aspect of the invention includes a commutator member made of electrically conductive resin and a commutator portion made of non-electrically conductive resin, which is constructed of a commutator support member for supporting the commutator member integrated with the commutator member. The commutator portion is fixed to an axle.

The second aspect of the invention enables the commutator member which is made of electrically conductive resin to be easily integrated to make the commutator portion. In addition, an insulating portion formed on adjacent commutator members is able to be easily made during the forming to make an integrated unit, thereby obviating the need for the post processes of slit forming and the like.

### BRIEF DESCRIPTION OF THE DRAWINGS

FIG. 1A is a front view showing a partial cross-section of a motorized fuel pump for a vehicle according to the invention, and FIG. 1B is a diagram showing a cross-section taken along line IA-IA of a commutator portion of the motorized fuel pump for a vehicle shown in FIG. 1A;

FIG. 2A is a front view showing a partial cross-section of a motorized fuel pump for a vehicle according to the invention, and FIG. 2B is a diagram showing a cross-section taken along line IIA-IIA of a commutator portion of the motorized fuel pump for a vehicle shown in FIG. 2A;

FIG. 3 is a cross-sectional view of a related motorized fuel pump for a vehicle; and

FIG. 4A is a front view of a commutator and a brush portion of a related motorized fuel pump for a vehicle, and FIG. 4B is a front view of the commutator portion of the related motorized fuel pump for a vehicle shown in FIG. 4A.

### DETAILED DESCRIPTION OF THE PREFERRED EMBODIMENTS

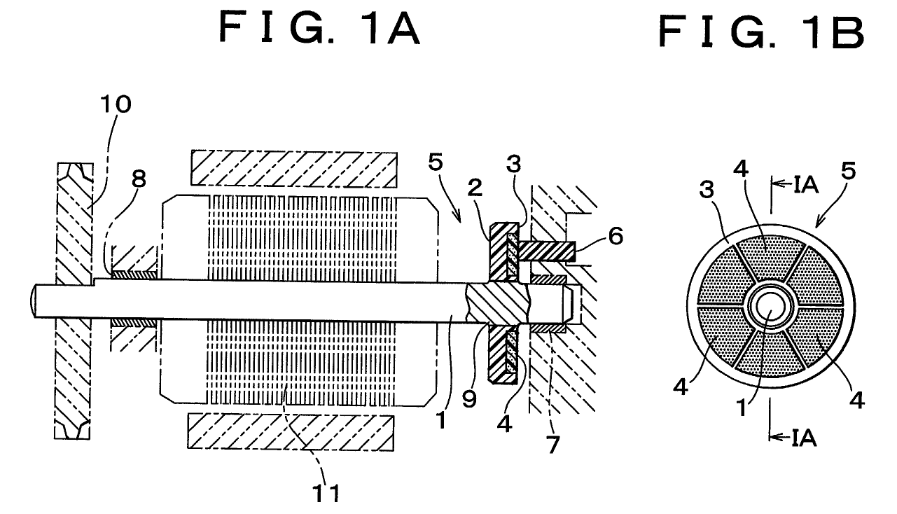

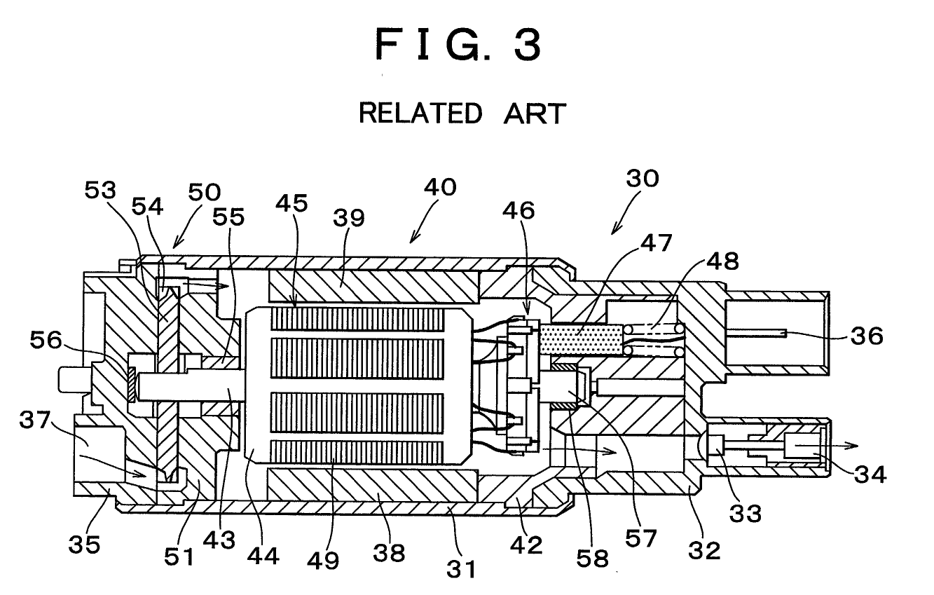

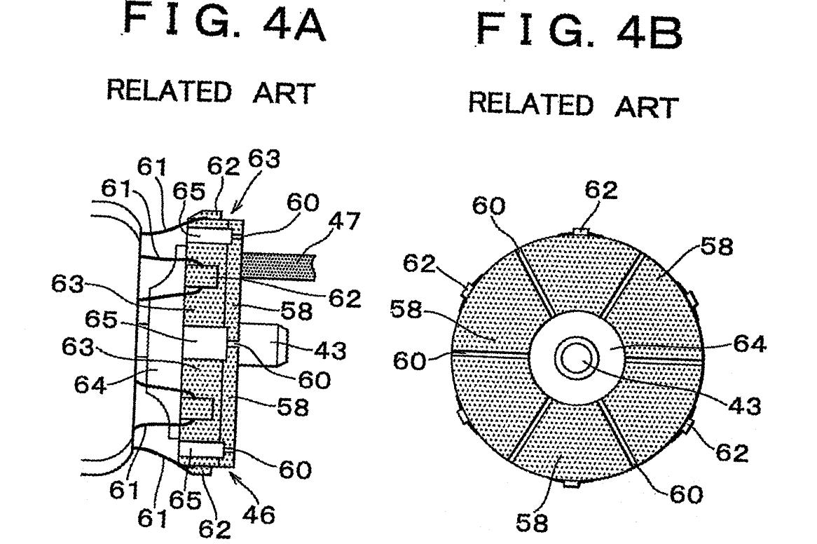

Hereinafter, exemplary embodiments of the invention will be described with reference to the drawings. FIGS. 1A and 1B show an example in which the invention has been applied to the related system shown in FIG. 3. According to the exemplary embodiment shown in FIG. 1A and FIG. 1B, a commutator support member 2 of non-electrically conductive resin is fixed to an axle 1. Six commutator members 4 of electrically conductive resin, as shown in FIG. 4B, are integrated by insert-forming or dichroic-forming or the like, with an end face 3 side of this commutator support member 2, and a commutator portion 5 of electrically conductive resin is formed with the six commutator members 4. Accordingly, the commutator support member 2 of non-electrically conductive resin is disposed in between each commutator member 4 of electrically conductive resin, such that each commutator member 4 is insulated.

Also according to this exemplary embodiment, the brushes 6 which make sliding contact with the commutator 4 are made of electrically conductive resin, just as is the commutator 5, and just like the related art, the ends of the brushes 6 are constantly urged with springs so as to be abutted against the commutator member 4. In the exemplary embodiment shown in FIG. 1A and FIG. 1B, the commutator portion 5 and the brushes 6 are both made of electrically conductive resin. However, even if only one of the two is made of electrically conductive resin, as in another exemplary embodiment according to the invention, the effect of preventing a reduction in conductivity is far greater than related art made of metal or carbon.

The aspects of supporting both end portions of the axle 1 with bearings, fixing the pump, and fixing the thin iron core sheets and the like are the same as those of the related art shown in FIG. 3. These are shown for reference, denoted by the thin chain double-dashed line and the like in FIG. 1A.

According to the invention as described above, the commutator and brushes, in particular, are made of electrically conductive resin. Although various types of resin may be used, a resin containing carbon is preferable. Also, electrically conductive polyamide resin that is a compound of electrically conductive carbon black and a resin having a polyamide base has particularly good resistance to gasoline and is also highly electrically conductive.

As a polyamide, a polymer obtained from polycondensing 6-hexane lactam, 6-aminocaproic acid, ω-enanthic lactam, 7-amino heptanoic acid, 9-amino nonanoic acid, 11-amino undecanoic acid, ω-lauroyl lactam, 12-amino decanoic acid, α-pyrrolidone, or α-bipyrrolidone, a diamine such as hexamethylene diamine, nanomethylene diamine, undecamethylene diamine, dodecamethylene diamine, metaxylylene diamine, 1, 4-bis (amino methyl), cyclohexane acid, and a dicarboxylic acid such as terephthalic acid, isophthalic acid, adipic acid, sebacic acid, dodecanedioic acid, or cyclohexanedicarboxylic acid, or a copolymer from two or more or the aforementioned monomers may be used. Further, the resin can also be selected from among various resins used in conventional electrically conductive resin manufacturing.

The essential requirements for electrically conductive carbon black are that the structure is highly developed, there are few impurities on the particle surface, and there is a large specific surface area. Products sold under the names of Ketjenblack and Ketjenblack EC600JD by Akzo Nobel in the Netherlands are examples of this type of electrically conductive carbon black. When combining this electrically conductive carbon black with a resin such as one of those described above, a coupling agent such as a silane or titanate coupling agent is used as necessary. Further, in order to increase the strength of the resin, it is preferable to mix in glass fiber to make it reinforced resin. According to this invention, a combination is selected for particularly good oil resistance, sulfur resistance, wear resistance, and electrical conductivity from among the various aforementioned resins and an electrically conductive material to be mixed therewith.

When fixing the commutator members 4 formed from this type of material to the end face 3 on one side of the commutator support member 2, it is possible to form them integrated by insert-forming, in which the pre-formed commutator member 4 is arranged and fixed within the mold before molding the commutator support member 2 made of non-electrically conductive resin, or by dichroic-forming or the like. The thus formed commutator portion 5 can be fixed by, for example, being press-fitted onto a spline coupling portion formed on a pre-manufactured commutator fixing portion 9 of the axle 1, as shown in FIG. 1.

As shown in FIG. 1A and FIG. 1B, and just as in the related art shown in FIG. 3, the end of the thus formed commutator portion 5 on the right side in the figure is supported by a bearing 7 and the portion of the commutator portion 5 on the left side in the figure is supported by a bearing 8. A pump 10 is connected to the end of the commutator portion 5 on the left side in the figure and an iron core 11 of the rotor of the motor is connected to the portion of the commutator portion 5 in the center in the figure.

When fixing the commutator support member 2 to the axle 1, or when molding so as to fix the commutator member 4 to the commutator support member 2, as described above, it is also possible to arrange the metal axle in the center portion of the mold and form the commutator support member 2 integrated with the axle 1 by filling resin into the mold.

In this way, when integrally molding the commutator member 4 with the commutator support member 2, adjacent commutator members are insulated either by the non-electrically conductive resin filled in the space between adjacent commutator members 4 or simply by the space itself. This obviates the need for the post processing of forming the commutator with disc-shaped copper alloy plates and then making slits in the commutator support member that supports those plates, as with the related art.

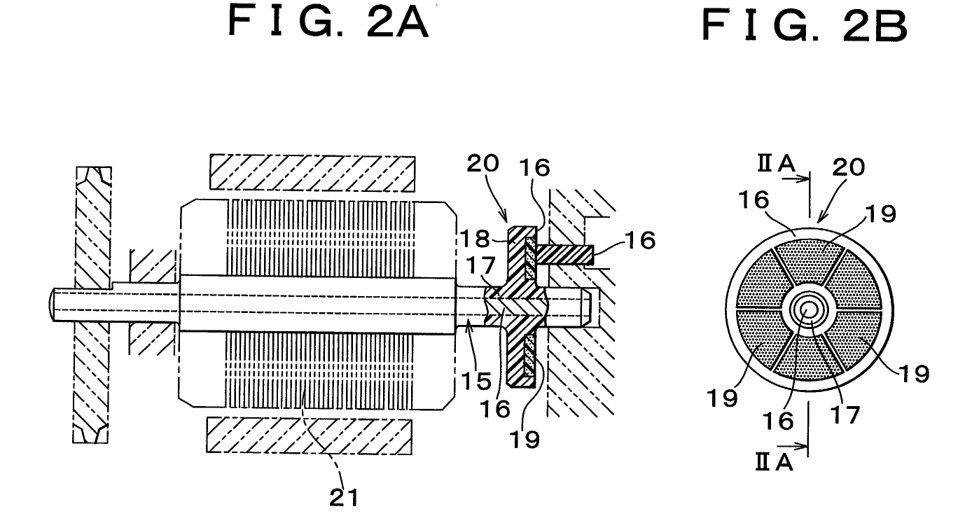

When molding the commutator support member 2, the commutator member 4 and the axle 1 can be integrated with the commutator support member 2 by insert-forming, as described above. That is, a metal reinforcement axle core 16 is provided at the center of the axle 15, and then the periphery of this reinforcement axle core 16 is covered with resin 17, as shown in FIG. 2A and FIG. 2B, for example. In particular, the portion that creates the exterior shape of the axle 15 is formed by the resin 17 cover.

Also in the embodiment shown in FIG. 2A and FIG. 2B, the type of resin 17 for covering the reinforcement axle core 16 is the same as the resin of the commutator support member 18. The commutator member 19 is fixed to the commutator support member 18, which together make up the commutator portion 20, just as in the embodiment shown in FIG. 1.

When manufacturing this type of commutator portion 20 which is integrated with the axle 15, the metal reinforcement axle core 16 is arranged in the center of the mold, just as in the embodiment shown in FIGS. 1A and 1B, and the pre-molded commutator members 19 made of electrically conductive resin are arranged radially with spaces therebetween. A product as shown in FIGS. 2A and 2B is formed by filling the mold with non-electrically conductive resin.

In this way, because there is resin on the outer peripheral surface of the axle 15, the bearing portion is able to have excellent wear resistance so there is no need to provide bearings to support the axle 15, as shown in FIG. 2A, which in turn enables the pump to be less expensive. Also, the resin portion on the outer periphery of the axle 15 can be easily formed in any shape. Accordingly, when fixing the iron core sheets 21 of the rotor to the axle 15, the outer periphery of the axle 15 can be shaped into an appropriate polygon shape or formed with a key-shaped portion and the hole formed in the center portion of the iron core sheets 21 can be of a shape that matches the polygon shape or key-shaped portion of the outer periphery of the axle 15, thereby easily forming a means to prevent the axle 15 from turning independently of the iron core sheets 21 of the rotor. Further, it is possible to reliably fix the iron core sheets 21 of the rotor to the axle 15 with relatively little force.

Also, the resin portion around the axle can be made by insert-forming at the same time the commutator is being integrally formed.

The exemplary embodiment shown in FIGS. 2A and 2B is shown having a metal reinforcement axle core in the axle and a resin coating around this reinforcement axle core. However, when the resin is of sufficiently high strength, there is no need for this reinforcement axle core. Also, both of the foregoing exemplary embodiments were described with the commutator member that partially forms the commutator portion being of a construction in which the ends of brushes make sliding contact with the end face of the commutator member. However, the invention can also be applied to a motorized fuel pump for a vehicle having a commutator portion which uses, for example, a commutator member having a cylindrical outer peripheral surface, and which is such that the brushes make sliding contact with the cylindrical outer peripheral surface of that commutator member. Further, this invention can be implemented with further variations and modifications as necessary.

What is claimed is:

1. A motorized fuel pump for a vehicle, comprising:
a commutator member arranged around a motor axle, and
a brush which makes sliding contact with the commutator member,
wherein
at least one of the commutator member and the brush is formed of electrically conductive resin.

2. The fuel pump according to claim 1, wherein at least one of the commutator member and the brush is molded with electrically conductive resin.

3. The fuel pump according to claim 1, wherein the electrically conductive resin is a resin containing carbon.

4. The fuel pump according to claim 1, wherein the electrically conductive resin is an electrically conductive polyamide resin in which electrically conductive carbon black has been combined with a resin having a polyamide base.

5. A motorized fuel pump for a vehicle, comprising:
a motor axle,
a plurality of commutator members arranged around the motor axle with predetermined spaces between adjacent commutator members in a peripheral direction of the motor axle, the commutator members being formed of electrically conductive resin, and
a support member for supporting the commutator members on the motor axle, the support member being formed of non-electrically conductive resin and at least a portion of the support member being arranged within the predetermined spaces between adjacent commutator members.

6. The fuel pump according to claim 5, wherein the commutator members and the support member are integrally molded.

7. The fuel pump according to claim 6, further comprising:
a resin portion on at least an outer periphery of the motor axle,
and the resin portion is formed with the same material as the support member when integrally molding the commutator members with the support member.

8. The fuel pump according to claim 7, wherein the motor axle is integrally molded with the support member through the resin portion.

9. A motorized fuel pump for a vehicle, comprising:
a motor axle,
a commutator member formed of electrically conductive resin, and
a support member which is integrated with the commutator member for fixing the commutator member to the motor axle, the support member being formed of non-electrically conductive resin.

10. The fuel pump according to claim 9, further comprising:
a resin portion on at least an outer periphery of the motor axle,
and wherein the resin portion is formed with the same material as the support member when integrally molding the commutator members with the support member.
